(19) United States
(12) Patent Application Publication
(10) Pub. No.: US 2014/0305829 A1
(43) Pub. Date: Oct. 16, 2014

(54) ORGANIZING SYSTEM WITH PACKING BOXES

(71) Applicant: Peter Roesler, Wangen (DE)

(72) Inventor: Peter Roesler, Wangen (DE)

(21) Appl. No.: 14/251,741

(22) Filed: Apr. 14, 2014

(30) Foreign Application Priority Data
Apr. 12, 2013 (DE) 10 2013 006364.7

(51) Int. Cl. B65D 21/02; B25H 3/02

(52) U.S. Cl. CPC B65D 21/0202; B25H 3/021
USPC 206/511; 220/23.83

(57) ABSTRACT

An organizing system with packing boxes formulated as containers, each packing box having a floor wall and one or more legs attached thereto which are adapted to interlock with retainers on a catch plate. The retainers may have undercuts which may match a convex outward orientation of the legs. Further, the retainers and the legs may be elastically flexible so that engagement of the two may be through elastic deformation to form a strong but releasable latching engagement.

### BACKGROUND OF THE INVENTION

1. Technical Field of the Invention

The presently disclosed invention pertains generally to an organizing system with packing boxes which are releasably attachable to a catch plate. More specifically, the presently disclosed invention pertains to packing boxes comprising one or more legs which may be engaged with and held securely by retainers on a catch plate.

2. Description of the Related Art

Organizing systems which hold individual boxes or containers in a fixed but releasable position are known in the art, for example, from the subject matter of European Patent No. EP 1044083 B1. With that device disclosed therein, objects as desired are placed with their bottom sides on a mat that is equipped with studs having grid spacing. For that purpose, studs that are round in shape are arranged on the bottom side of the objects that are to be placed on the studded mat (for example, packing boxes or other boxes of an organizing system that are open on the top) which mesh with the space in between the bottom-side studs of the studded mat.

The disadvantage of this arrangement is that only a frictional contact takes place between the bottom-sided studs of the packing containers and the studded mat. Such an organizing system is not suitable for being arranged in a portable toolbox because the frictional contact hold between the studs is not sufficient by itself for a firm seat if the toolbox is rotated and turned over in any spatial position. Further, the organizing system cannot be fastened in a vertical arrangement to a wall because, with loaded containers, the frictional contact between the studs of the holder that mesh with each other is not sufficient.

With the subject matter of German Patent No. DE 19641686 C2, it is known to arrange studs on the bottom side of a container which, for instance, are rectangular or square in shape. The studs that are represented there are formulated as shapes on the metal floor of a stacking box. They are not intended for meshing with an assigned retainer. Rather, it consists of stackable boxes which can be stacked offset from one another in correspondence to the grid distance of the studs.

With the subject matter of European Patent No. EP 1796970 B1, another organizing system was previously known having a number of stud-shaped recesses formed on the interior side of a toolbox into which associated projections of containers that have been inserted therein mesh. Here, as well, the disadvantage exists that the fastening consists of a frictional connection and not a catch connection. Consequently, this system cannot bear a load, and in particular, if the toolbox is carried upright there are no counterforces working on the containers that have been inserted into the recesses on the floor that open toward the top. For that reason, the danger exists that the containers may fall out.

Containers in the previously known tool systems in general need to be subjected to a load from a counter pressure that is generated from the interior side of the hinged lid in order to avoid unintended displacement of the containers that are placed in the stud receptacles. The counter pressure is generated by a foam mat or something similar. As such, the frictional contact that is used is not sufficient by itself to securely hold the containers that are placed in the stud-shaped retainers on the floor side.

While German Patent No. DE 19641686 C2 depicts plug-in legs that are arranged on the floor-side of a container; these merely mesh with the upper edge of another container that is placed underneath and merely form a compression connection. Such a compression connection achieves only slight retention forces.

US Patent Publication No. 2004/0074902 A1 depicts a ring-shaped form of a plate or another dish which has ribs that are equally distributed on the outer perimeter extending outward radially. The plate can be turned upside down and can be placed on another plate that is sitting upright, and the two edge areas can be engaged with each other. Consequently, what is disclosed are two identical parts that are arranged as a mirror image to one another which can be engaged with each other on the perimeter edge area. There are therefore no engaging legs, but rather a perimeter edge. Further, the equal edge which runs the entire extent of the perimeter is difficult to engage.

U.S. Pat. No. 5,699,925 B discloses two case-like containers positioned over each other whereby the container sides are connected with the help of dovetail joints that reach into each other. A catch connection is not to be deduced there.

In general, it holds true that the arrangements of the prior art merely generate clamping forces between surfaces that are adjacent to each other. Such clamping connections belong to the category of frictional contact connections and cannot generate any additional retention force because the connection can be undone by overcoming an additional latching force. With the loosening of a latch connection, on the other hand, the latching force which ranges far beyond the clamping force must first be overcome before the clamping connection is also undone by the application of another, lower force. A latch is provided by a locking of two parts that are assigned to each other, while a clamp connection is provided merely by a meshing of two parts that are formulated as tapering to each other without one part locking with the other part.

For each of the reason discussed above, the problem that forms the basis of the presently disclosed invention is to develop an organizing system with packing boxes of the type mentioned in the beginning in such a way that a substantially better holding force (e.g. connection with a greater retention force) is provided between the individual packing boxes or containers and the floor-side retainer on any fastening surface. Such connection may be achieved without additional fastening or counter pressure means being necessary to secure the boxes in position.

### SUMMARY

The presently disclosed invention overcomes many of the shortcomings of the prior art by providing an organizing system wherein at least one packing box that includes a floor wall and a plurality of upstanding side walls defines a containment area. The floor wall includes one or more legs that are convexly oriented outward. The organizing system further includes a catch plate that has a plurality of integral retainers. The retainers open upward and are adapted to interlock with the one or more legs on the packing box, wherein the integral retainers have undercuts that match the convex outward orientation of the legs on the at least one packing box.

The presently disclosed invention also relates to an organizing system wherein at least one packing box includes a floor wall and a plurality of upstanding side walls that define a containment area. The floor wall includes one or more legs which are elastically flexible. The organizing system also includes a catch plate that has a plurality of integral, elastically flexible retainers that open upward and are adapted to interlock with the one or more legs on the at least one packing box through elastic deformation.

A feature of the presently disclosed invention is that the floor sides of the containers have legs that can be engaged in the manner of latch connections with associated retainers on the floor side of the organizer, leading to substantially better load capacity of the plug connector. It therefore includes a connection that is not only based upon frictional contact between elements, but additionally, as a result of the associated latching elements engaging with each other, a latching connection between the floor surfaces of the container and the retainers of the floor surface of the organizing system.

Thus, the advantage provides that containers of any type—that can also be closed with a lid and which have a considerable filling volume and a corresponding weight—can be engaged to a floor surface which may be oriented in any direction, such as horizontally, vertically or hanging.

It is also provided that for containers which may be heavy, the latch connection may not be broken, and thus the organizing system may be formulated for a wide range of organizing systems such as, for example, toolboxes, assembly kits, sales displays, display units, and the like. The organizing system may be designed in such a way that the containers, for example containers which are to be sold, and which may be closed with a lid and filled with small objects (e.g. screws or other small parts) cannot fall out of their latch retainers, even if the latch retainers are arranged as wall-hanging panels.

In a preferred implementation of the presently disclosed invention, it is provided that the legs that are arranged on the bottom wall of the corresponding container are oriented convexly, that is, on their fastening surface on the container-side floor they have a smaller mutual distance than on the catching surface that is away from the container floor, and thus they are arranged with a tapered orientation toward each other in the oblique angle and mesh with the associated latch retainers in the floor surface that run opposite.

With the arrangement of catching legs on the floor surface of a container, the advantage results that the legs provide for a more secure, tipping-free condition of the containers on a level installation surface, and in addition, the further advantage results that the legs can be used for the stacking of the containers. The containers may be stacked with each other and the legs may be arranged close to the lateral surface of the containers in such a way that with containers that are stacked over each other, the corresponding outer legs mesh in the interior space of the container that lies over it, and as a result of this, a stacking of several containers positioned over each other in a manner that is secure from shifting is possible.

Likewise, the containers may also be arranged offset from each other in that a stacking is also possible with containers that are arranged offset from each other because containers that lie over each other offset are arranged in such a way that the lower container meshes with the edge of its floor into the intermediate space or behind one or more of the legs of the container positioned above.

This presently disclosed invention therefore has the advantage that a double application purpose can be achieved, namely, first a secure catch connection between containers and a catch plate with associated catch recesses, and second the possibility exists to store containers positioned over each other in a stackable manner that is secure from shifting. For the production of a catch connection, it is furthermore provided that the catch retainers in the catch plate are formulated in an elastically flexible manner and have undercuts into which the container-side legs engage under elastic deformation.

In a preferred implementation, the presently disclosed invention includes a design in which the engaging legs (approximately stalk-shaped and/or curved into an arch shape and/or obliquely oriented toward the outside) are arranged on the floor side of the container and the catch retainers that are open toward the top are provided on the catch plate.

The presently disclosed invention also includes embodiments which are the kinematic reversal, namely, the catch retainers are provided on the underside of the containers and the engaging legs which are oriented toward the top are arranged on the upper side of a catch plate.

In an additional embodiment of the presently disclosed invention, it is provided that the containers can each be closed with a lid, whereby in particular an engaging or non-engaging hooded lid is preferred. However, swinging lids may also be used.

Furthermore, it is preferable for a hanging bracket to be arranged on the side wall of the container that is formulated in a film hinge that can swivel in parallel to a side wall of the container. Thus the advantage results that with the swiveling in of the hanging bracket, a saving in space is possible with a dense linking together of containers on the catch plate.

In an additional embodiment of the presently disclosed invention, it is provided that with containers that are linked together which push against each other on the edge side (on the catch plate), access openings are provided in the edge areas of the lids that push against each other. Within that context, it is presupposed that the containers are closed, for example, with a hooded lid or another flexible lid, and that the hooded lids of four (or two) containers that intersect in a corner area form (in that area) a round access opening.

The corners of all four (or two) hooded lids of containers that engage in the grid spacing onto the catch plate therefore intersect with each other in the area of an access opening. In order to then be able to open the lid of a container, it is provided that a finger can be reached into the access opening, whereby it is intended that the finger bends down the corner of the hooded lids of the containers that project into the access opening there which are not to be opened, and with a finger of the same hand, the hooded lid is then lifted that belongs to the container that is to be opened.

In addition, the presently disclosed invention is not restricted to a catch mat that forms catch retainers. It goes without saying that with all other embodiments that are not described in greater detail here, it is provided that the profile forms of the catch retainers of the catch mat works together with the profile form of the latching element on the floor side of the container in order to in this way render a catch connection.

Instead of a catch plate with catch retainers formed in it, in another implementation it is provided to use a catch grid which, in turn, consists of catch retainers that are formed by double T-shaped profile rods which are also described as catch strips, and behind their double T-shaped profile the legs of the container engage. Double T-shaped undercuts of that kind may therefore also form the catch profile of the catch plate.

The inventive object of this presently disclosed invention results not only from the subject matter of the individual patent claims, but rather also from the combination of the individual patent claims among each other. All of the statements and features that are disclosed in the documents, including in the abstract, in particular the physical formulation that is depicted in the drawings, are claimed as essential to the presently disclosed invention to the extent that they are new with respect to the state of the art either individually or in combination.

### BRIEF DESCRIPTION OF THE DRAWINGS

The presently disclosed invention is explained in greater detail below through the use of drawings that represent merely one path of an embodiment. Within that context, additional features that are essential to the presently disclosed invention and advantages of the presently disclosed invention also emerge from the drawings and their description.

FIG. 1 illustrates a sectional view of an embodiment of a container that is standing on a flat base in accordance with certain aspects of the presently disclosed invention;

FIG. 2 illustrates the representation according to FIG. 1 wherein the container is engaged in a catch plate in accordance with certain aspects of the presently disclosed invention;

FIG. 3 illustrates the engaging process of the container according to FIGS. 1 and 2 into the catch plate according to FIGS. 2 and 3;

FIG. 4 illustrates engagement of the container according to FIG. 3 into the catch plate according to FIG. 3;

FIG. 5 illustrates the kinematic reversal of the catch plate that is represented in FIG. 4;

FIG. 6 illustrates the engaging process of the legs of a container into the catch retainers of the catch plate in accordance with certain aspects of the presently disclosed invention;

FIG. 6a illustrates the floor-side arrangement of the legs on a container in a first embodiment in accordance with certain aspects of the presently disclosed invention;

FIG. 6b illustrates the various possibilities of the floor-side arrangement of legs on a container in accordance with certain aspects of the presently disclosed invention;

FIG. 7 illustrates the completed engaged state of the container according to FIG. 6 into the catch retainers of the catch plate in accordance with certain aspects of the presently disclosed invention;

FIG. 7a illustrates the floor-side view of the legs of the container with the representation of various profile shapes and arrangements of legs in accordance with certain aspects of the presently disclosed invention;

FIG. 8 illustrates another embodiment of the formulation of legs that are formulated not as separate individual elements, but rather as engaging profile studs in accordance with certain aspects of the presently disclosed invention, whereby the elastic deforming of the legs on the container and the elastic deformation of the catch retainers on the catch plate is also represented;

FIG. 8a illustrates the top view of various arrangements and profile shapes of legs in accordance with certain aspects of the presently disclosed invention;

FIG. 8b illustrates another implementation of a leg in accordance with certain aspects of the presently disclosed invention;

FIG. 8c illustrates an implementation of a leg that has been modified with respect to FIG. 8b;

FIG. 9 illustrates a top view of a first embodiment of a container with a swiveling hanging bracket in accordance with certain aspects of the presently disclosed invention;

FIG. 10: illustrates the side view of the arrangement according to FIG. 9;

FIG. 11 illustrates another embodiment of a container with a swiveling hanging bracket in accordance with certain aspects of the presently disclosed invention;

FIG. 12 illustrates the container form according to FIG. 11 with a swiveled hanging bracket;

FIG. 13 illustrates a top view of several containers that are linked together with each other with the help of a hanging bracket in accordance with certain aspects of the presently disclosed invention;

FIG. 14 illustrates a side sectional view of a container before engaging with a hooded lid in accordance with certain aspects of the presently disclosed invention;

FIG. 15 illustrates the container according to FIG. 14 with the hooded lid engaged;

FIG. 16 illustrates a second embodiment of a container with a sliding-blister cover in accordance with certain aspects of the presently disclosed invention;

FIG. 17 illustrates a third embodiment of a container with a swinging lid in accordance with certain aspects of the presently disclosed invention;

FIG. 18 illustrates a top view of a catch plate with catch retainers that are formulated as square and catch retainers that are profiled as round in accordance with certain aspects of the presently disclosed invention;

FIGS. 19 and 20 illustrate the top view and the side view of a lid opening for containers with hooded lids, the containers being linked together, in accordance with certain aspects of the presently disclosed invention;

FIG. 21 illustrates the top view of the floor side of a container with standing legs or engaging legs in accordance with certain aspects of the presently disclosed invention;

FIG. 22 illustrates the replacement of the catch plate by a catch grid mat in top view in accordance with certain aspects of the presently disclosed invention; and

FIG. 23 illustrates a sectional view in accordance with the line A-A according to FIG. 22 through the catch grid mat.

### DETAILED DESCRIPTION

In the following description, the presently disclosed invention is set forth in the context of various alternative embodiments and implementations involving an organizing system with packing boxes. While the following description discloses numerous exemplary embodiments, the scope of the present patent application is not limited to the disclosed embodiments, but also encompasses combinations of the disclosed embodiments, as well as modifications to the disclosed embodiments.

Various aspects of the organizing system with packing boxes may be illustrated by describing components that are coupled, attached, and/or joined together. As used herein, the terms “coupled”, “attached”, and/or “joined” are interchangeably used to indicate either a direct connection between two components or, where appropriate, an indirect connection to one another through intervening or intermediate components. In contrast, when a component is referred to as being “directly coupled”, “directly attached”, and/or “directly joined” to another component, there are no intervening elements shown in said examples.

The drawings disclose a new kind of organizing system which is characterized by a container 1 correspondingly being equipped with floor-side legs 4 that are oriented obliquely toward the outside of the floor surface which may be engaged into the associated catch retainers 6 of a catch plate 13. The container 1 consists in general form of side walls 2 and a bottom wall 3 on the underside of which the aforementioned legs 4 are formed.

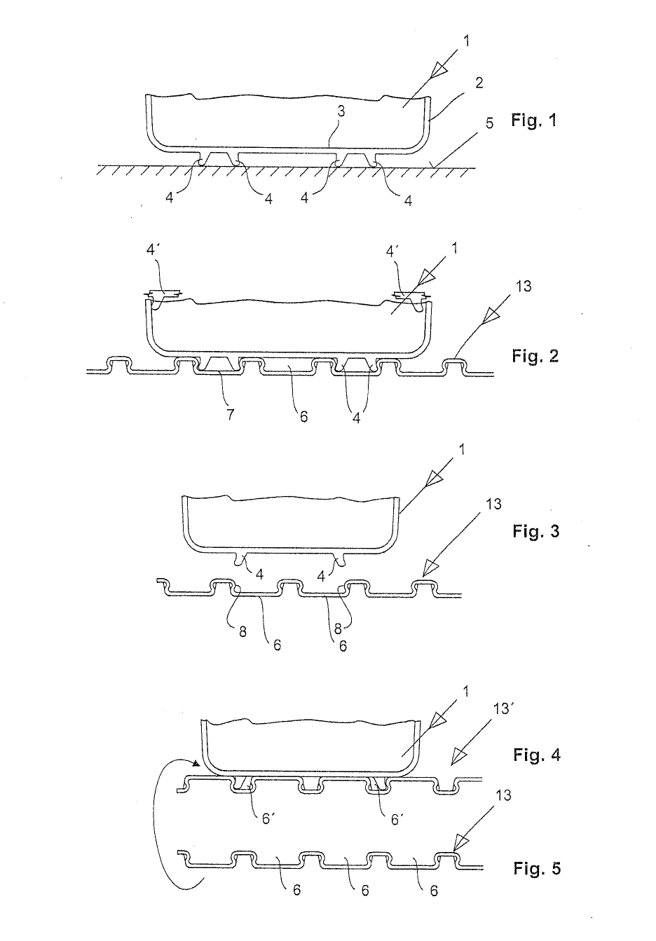

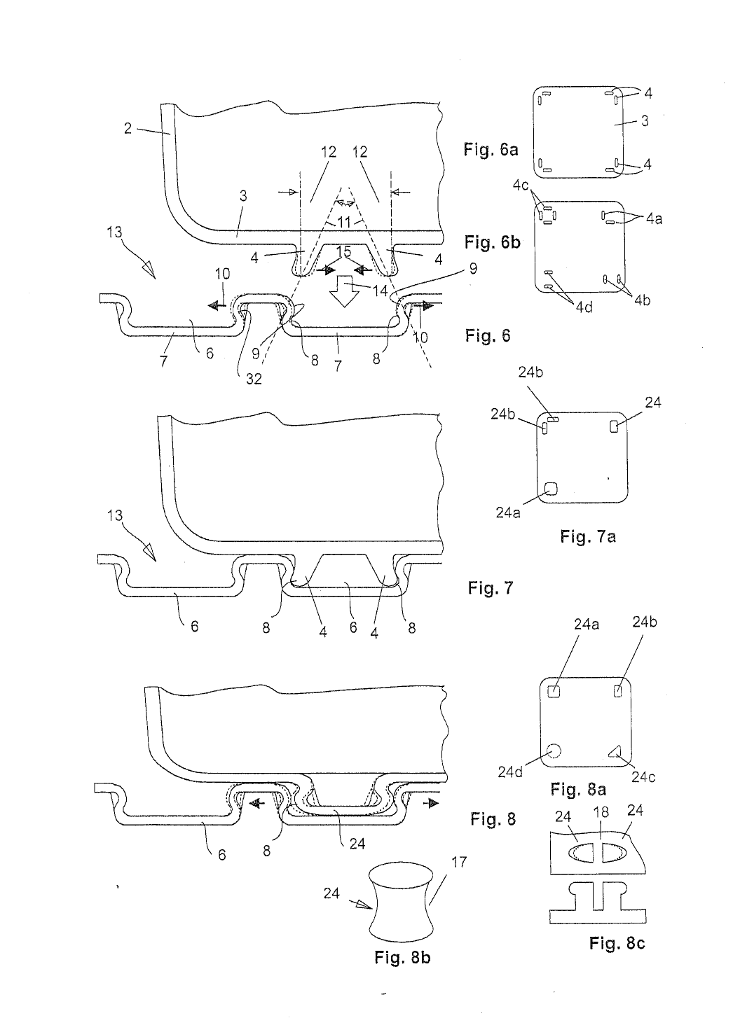

FIG. 2 depicts the engaging of the legs 4 that are represented in FIG. 1 into the associated catch retainers 6 of a catch plate 13, whereby in connection with FIG. 6, it can be recognized that with the engaging of the legs 4, an elastic deformation occurs at both the legs and the undercuts 8 in the area of the catch retainers 6 of the catch plate 13, such that a secure catch connection is provided. Since with a dense spacing, the legs 4 are each opposingly oriented as tapered, a mutual distorting of the legs 4 in the area of the catch retainer 6 of the catch plate 13 occurs such that a catch situation that is secure against shifting is achieved.

FIG. 3 depicts the embodiment according to FIGS. 1 and 2, where it can be recognized that the legs 4, which may be placed and support the container 1 on a flat base 5, may be engaged in undercuts 8 of the catch retainers 6. Such an embodiment is also represented in FIG. 4, except that there, the catch retainers are formulated to be very small; specifically, in a kinematic reversal to the representation in FIG. 3, the catch retainers 6′ are now arranged in the area of the smaller stud-shaped or grid-shaped catch retainers of the catch plate.

FIG. 5 depicts the kinematic reversal of FIG. 4, whereby the catch plate 13′ that is depicted in FIG. 4 can also be turned over or rotated by 180 degrees to achieve the representation according to FIG. 5, such that the legs 4 can then engage in the catch retainers 6 that are now spaced further apart. In this way, the catch plate 13 has a doubled effect, because it is formulated as catch retainers 6, 6′ both from the upper side and from the lower side which can be used depending upon the choice of the catch position and the orientation of the container 1. This requires that the legs 4 be formulated in specific grid spacing which is similar to the spacing of the catch retainers 6, 6′ of the catch plate 13, 13′.

FIGS. 6, 6a, and 6b depict various possibilities of engaging the legs 4 with the retainers 6. FIG. 6 illustrates the axes 11 which describe the longitudinal axes through the legs 4 which are obliquely oriented toward the outside and consequently form an angle 12 to the corresponding verticals. Conversely, the catch retainers 6 each form a floor surface 7 which is laterally limited by catch projections 9, said catch projections 9 rising up from the floor surface 7 and forming undercuts 8.

FIG. 6 depicts that if the engaging between the legs 4 with the retainers 6 takes place in the direction of the arrow 14, then the legs 4 elastically bend inward and reduce the mutual distance in the direction of the arrow 15, while conversely, the catch projections 9 are elastically bent toward the outside in the direction of the arrow 10, such that the legs 4 reach with their front free ends into the space of the undercuts 8 behind the catch projections 9. Thus, a flawless catch connection is present. Since the catch projections 9 are formulated as arched surfaces or other rounded surfaces, a simple insertion of the legs 4 into the catch retainers 6 of the catch plate 13 is possible without the engaging involving difficulty or it leading to a damaging of the legs 4.

FIG. 6a depicts in a first embodiment that the legs 4 are each arranged offset at an angle of 90 degrees to each other on the floor wall 3 of the container 1, whereby the legs 4 are preferably arranged in the outer corner area of the container 1. As a result of this, the stability of the legs is also improved because the floor wall 3 of the container 1 is formulated as especially stable in this corner area.

FIG. 6b depicts that the legs 4 may, however, also be arranged in a different way, as is represented with the legs 4a, 4b, 4c, and 4d. The arrangement on the corner side of the legs 4, 4a, 4b, 4c, and 4c1 according to FIGS. 6a and 6b has the additional advantage that the containers 1 are stackable because of this because the legs 4, 4a, 4b, 4c, and 4d of the upper container mesh in the container opening of an additional container 1 that is open upward and thus are stored in a manner that is secured against shifting on the container that lies below.

FIG. 6b furthermore depicts that the legs can be offset by an angle of 90 degrees from each other, as this is depicted with number 4a. Number 4b depicts that the legs 4 can also be arranged parallel and in a mutual distance to each other, whereby the legs can also be arranged according to number 4d in a different distance to each other. The configuration according to 4c depicts that a plurality of legs, for example four legs, each at an angle of 90 degrees also form a catch retainer that is oriented on four sides.

The presently disclosed invention is not restricted to the arrangements of the legs 4a, 4b, 4c, and 4d that are depicted in FIG. 6b each being arranged in a quadruple arrangement in the corner area of the container. In a different implementation, it can be provided that, for example, the legs 4a are arranged solely in a single corner area or diagonally opposite on the floor wall 3 of the container 1. It is likewise possible that any desired configuration of the legs according to 4a, 4b, 4c, and 4d be singularly arranged in the central area of the floor wall 3.

According to this, the presently disclosed invention comprises all of the configurations, combinations, and arrangements of legs 4, 4a, 4b, 4c, and 4d that either can be arranged singularly on the floor wall 3 of the container 1 or are also, for example, shifted diagonally in the corners or are also assigned in groups of four to each corner or are distributed as desired on the floor wall 3. The distribution of the legs therefore depends upon the grid spacing which is provided by means of the catch retainers 6, 6′ of the catch plate 13, 13′.

FIG. 7 shows the completed engaged state, with which it can be recognized that the free outside corners of the legs 4 that are bent toward the outside in the tapering form of an arch mesh in the undercuts 8 of the catch retainer 6 and are engaged there. Instead of the legs, which are formed as rib-shaped projections on the floor wall 3 of a container 1, it is also possible to use legs 24, 24a, and 24b that are closed in and of themselves. Within that context, FIG. 7a depicts that the legs 4 can also be formulated in the form of stud-shaped legs 24 that are formulated as a hollow section. FIG. 7a depicts various designs of the hollow sections that are represented as 24a, 24b, and 24 in FIG. 7a.

Within that context, FIG. 8 depicts one such stud-shaped leg 24 which is essentially formulated as a hollow section and which can be formulated either as a closed hollow section or as a hollow section that is open on one side.

According to FIG. 8b this stud-shaped profile can consist of one single projecting stud that forms a catch groove 17 in its wall area which is suitable to be engaged in the associated undercut 8 in the areas of the catch retainer 6. This is represented in FIG. 8a that various leg profile shapes 24a, 24b, 24c, and 24d can be provided, whereby such legs 24 can also be formulated as also divided among themselves, as this is represented in FIG. 8C. The leg there consists of a total of two halves that are separated from each other by a central notch 18 and thus are formulated as elastic. Each upper surface of the leg in all of the representations of FIGS. 8, 8a, 8b, and 8c is formed on the floor wall 3 of the container 1.

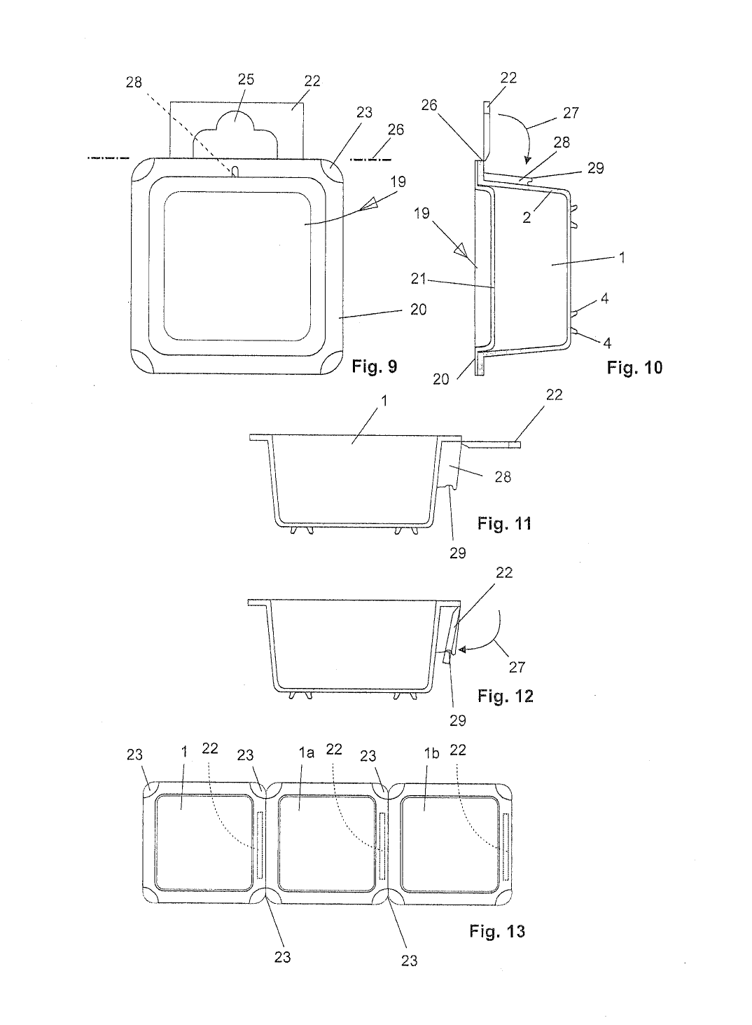

FIGS. 9 through 13 depict a possibility of linking together the containers that are linked together in a space-saving manner without the possible hanging brackets 22 that are arranged on the corresponding containers disturbing the linking together of the containers 1.

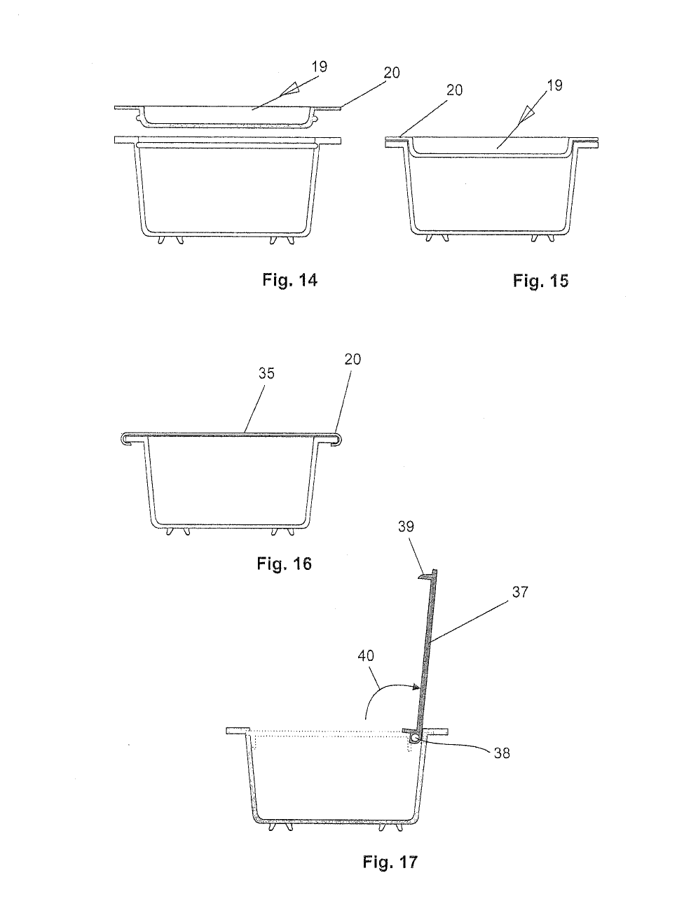

Within that context, FIGS. 9 and 10 depict a container 1 that is closed from above by means of a hooded lid 19. Every hooded lid 19 has a perimeter edge 20 which extends beyond the edge of the container, and a floor surface 21 that extends down starting out from the edge 20 which partially extends into the interior space of the container 1 and yields a frictional contact connection with the side wall 2 of the container 1. Thus the hooded lid 19 can be inserted under frictional contact into the retainer of the container 1 that is open toward the top. This is to be deduced from FIGS. 14 and 15.

FIG. 16 depicts a sliding cover 35, the edge areas 20 of which that lie opposite to each other encompass the perimeter edge of the container.

FIG. 17 depicts a swinging lid 37 which, in an axis of rotation 38 on the side of the container, runs on bearings and can swivel on one side in the direction of the arrow 40. On the free, swiveling end, a catch latch 39 is arranged for engaging with the opposite side wall of the container.

According to FIG. 9, a hanging bracket 22 is arranged on a side wall 2 of the container 1 on which, in a manner that has already previously been known in and of itself, an opening 25 is arranged for the access to a hanging hook. The hanging bracket 22 inventively runs on bearings and swivels in an axis of rotation 26 over a film hinge on the side wall 2 or swivels on the perimeter edge of the container 1. Therefore, the hanging bracket 22 can be swung downward in the direction of the arrow 27 and can be engaged on a retention bar 28 that is arranged on the side wall 2 of the container 1. For this purpose, the central opening 25 in the hanging bracket 22 swings over a catch stud 29 on the front end of the retention bar 28 and can be fixed there. FIG. 11 depicts another design of a retention bar 28, whereby the same catch stud 29, however, is used.

FIG. 12 depicts the swinging of the hanging bracket 22 in the direction of the arrow 27 and the engaging on the catch stud 29. For transport, therefore, the hanging brackets 22 are swung downward in the direction of the arrow 27 and are engaged with the catch stud 29 on the side wall 2 such that the containers 1, 1a, 1b according to FIG. 13 can be linked together in a space-saving manner. Only in the position of use, if the container is to be hung up on a hanging wall or the like, are the hanging brackets 22 released from their catch engagement with the catch stud 29 and once again swung into the swung-up position according to FIGS. 9 and 10.

Thus, it is possible for the first time to arrange so-called “self-service packagings” with legs 4 in a space-saving manner on a catch plate 13, 13′ and, at the same time, to see to it that the hooded lid 19 can be opened and closed in a particular way.

FIGS. 19 and 20 depict that the hooded lid 19 correspondingly carries an approximately semicircular recess 23 in the edge area and that the containers 1, 1a, 1b that are linked together correspondingly push against each other in the area of the side surfaces of their hooded lids. All of the semicircular recesses 23 of the hooded lids of containers 1, 1a, 1b, and 1c that push against each other consequently meet, as is represented in FIG. 20. Thus, an access opening 30 is defined in the corner area that pushes together of the hooded lids, as is represented in FIG. 20. Upon the opening of the hooded lid 19 of the container 1 according to FIG. 20, one of the edge areas is lifted while the opposite edge area of the other hooded lid 19 of container la is pushed downward. In this way, an easy removal of the corresponding hooded lid of containers that are linked together can take place with the finger 31 of one hand, and with this opening motion, the danger does not exist that the containers lift out of their catch connection with the catch plate 13, 13′, as was to be possible and problematic with the state of the art.

Even if large lifting forces are acting upon the hooded lid 19 for the loosening of the hooded lid according to FIG. 20, the lifting force is not sufficient to loosen the catch connection of the container 1, la on the floor wall 3 with the inventive legs 4 or the legs 24.

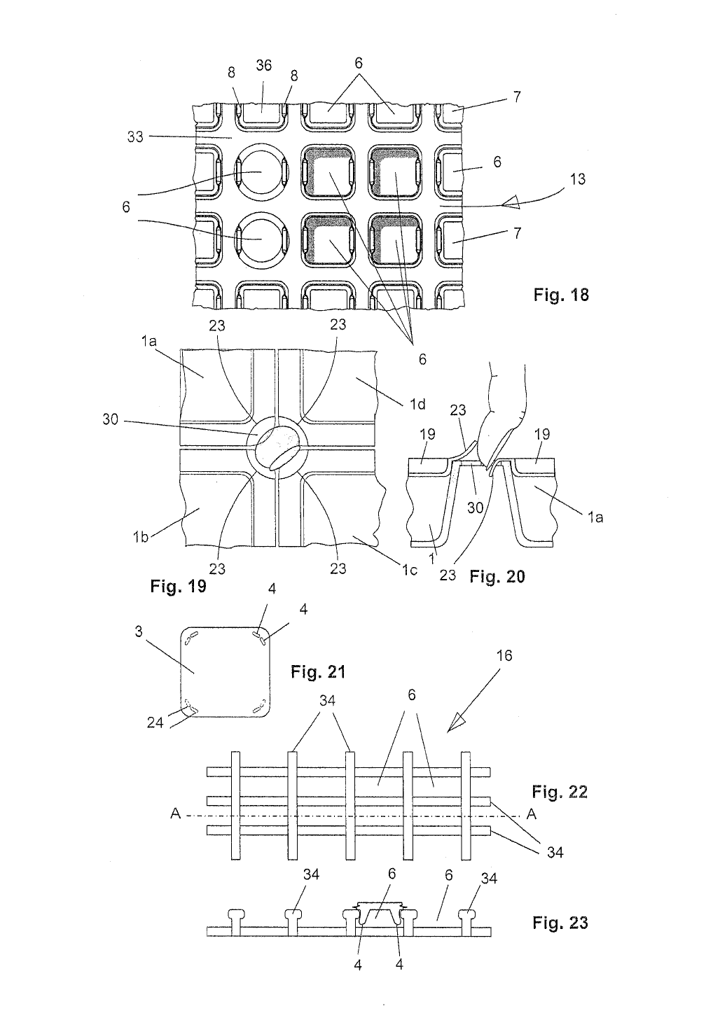

In FIG. 18, a top view of a catch plate 13 is depicted with a representation of various implementations of catch retainers 6. The catch retainers 6 are formulated as square profile forms that are open on one side and approximately cup-shaped. These profile forms are formulated, for example, as square in the top view, as this is likewise depicted in FIG. 18 through the use of another embodiment. Square or round catch retainers that alternate or are distributed as desired can also form the surface of the catch plate 13, 13′. This is shown by FIG. 18, where the profile forms which are depicted there can be combined with each other as desired or can also be present singularly.

It is not necessary for the solution that the catch retainers 6, 6′ be profiled as square or round. They can also have any other desired profile form such as, for example, a rectangular profile form, oval, elliptical, or in any other way desired. It only matters that starting out from one floor surface 36, side walls 32 extend upward, in the area of which the previously cited catch projections 9 are arranged with the associated undercuts 8. In the embodiment that is depicted, opposing undercuts 8 are provided in the area of the catch retainers 6 that are formulated as symmetric. Instead of the formulation of two opposing undercuts 8, as it is represented in FIG. 18, a total of four opposing undercuts can also be provided in the catch retainer 6. The undercuts 8 can be arranged opposite to each other in the corner area and/or in the side wall area.

In some cases, though, it is also sufficient to use one single undercut while the opposite side wall is formulated as smooth. Likewise, in an additional embodiment of this presently disclosed invention, it can be provided that the undercuts 8 that are opposite to each other are provided as diagonally opposite to the associated catch projections 9.

It is likewise also possible that the undercuts 8 are formulated as a ring groove that on the whole is circumferential and are limited by a circumferential catch projection.

A division (interruption) that is desired on the perimeter of the circumferential ring groove and on the catch projection that lies above it is also possible, such that, for example, six or eight divided or segmented undercuts of that type are provided with associated catch projections.

FIG. 21 depicts the arrangement of different types of legs 4 or stud-shaped legs 24 that are formed in any way on the floor wall 3 of the container 1 and must each fit with the grid spacing of the catch plate 13, 13′.

Because the presently disclosed invention provides an equal grid spacing for all engaging containers 1, it goes without saying that it is possible that the containers can be placed in any orientation that is desired on the catch plate 13. The containers may be placed both in the longitudinal direction and in the transverse direction or also diagonally on the associated catch retainer 6, 6′ of the catch plate 13, 13′. Any desired position orientation of the engaging containers 1 on the catch plate 13, 13′ is therefore possible.

As a substitute for a catch plate 13, 13′, FIGS. 22 and 23 depict that such a catch plate can also be formulated as a catch grid, whereby a plurality of intersecting grid bars 34 are provided, and the grid bars according to FIG. 23 have in section an approximately hammer-shaped (double T) profile that forms undercuts behind which the legs 4 or the stud-shaped legs 24 can be engaged.

With this embodiment, the floor wall 33 of the catch plate 13, 13′ does not apply, and there are only grid bars present in the area of which the catch profile is arranged. The intersecting grid bars 34 form between themselves the catch retainers 6.

While specific embodiments of the presently disclosed invention have been described in detail, it should be appreciated by those skilled in the art that various modifications and alternations and applications could be developed in light of the overall teachings of the disclosure. Accordingly, the particular arrangements, systems, apparatuses, and methods disclosed are meant to be illustrative only and not limiting as to the scope of the presently disclosed invention.

Drawings Legend

| | |
|---|---|
| 1 | Container |
| 2 | Side wall |
| 3 | Floor wall |
| 4 | Leg |
| 5 | Base |
| 6 | Catch retainer 6′ |
| 7 | Floor surface |
| 8 | Undercut |
| 9 | Catch projection |
| 10 | Arrow direction |
| 11 | Axis |
| 12 | Angle |
| 13 | Catch plate 13′ |
| 14 | Arrow direction |
| 15 | Arrow direction |
| 16 | Catch grid |
| 17 | Catch groove |
| 18 | Notch |
| 19 | Hooded lid |
| 20 | Edge |
| 21 | Floor surface |
| 22 | Hanging bracket |
| 23 | Recess |
| 24 | Leg a, b, c, d |
| 25 | Opening |
| 26 | Axis of rotation |
| 27 | Arrow direction |
| 28 | Retention bar |
| 29 | Catch stud |
| 30 | Access opening |
| 31 | Finger |
| 32 | Side walls |
| 33 | Floor wall |
| 34 | Grid bar |
| 35 | Sliding cover |
| 36 | Floor surface |
| 37 | Swinging lid |
| 38 | Axis of rotation |
| 39 | Catch latch |
| 40 | Arrow direction |

What is claimed is:

1. An organizing system comprising:
at least one packing box that includes a floor wall and at least one or more legs; and
a catch plate that includes a plurality of retainers that open upwardly and that define undercuts that engage the one or more legs to connect the at least one packing box with said catch plate.

2. The organizing system according to claim 1, wherein the plurality of retainers are arranged on the catch plate to form a grid pattern.

3. The organizing system according to claim 1, wherein at least one of said retainers and said legs are elastically flexible such that said legs engage said retainers under elastic deformation.

4. The organizing system according to claim 1, wherein the at least one packing box defines a containment area that includes a top portion that is closeable to form a sealed containment area of said packing box.

5. The organizing system according to claim 4, wherein the top portion of the containment area is a hooded lid, a sliding cover, or a swinging lid.

6. The organizing system according to claim 4, wherein one edge of the top portion of one of said packing boxes cooperates with an adjacent edge of the top portion of another packing box that is adjacent to said one packing box to form an access opening at times when the one and another packing boxes are engaged with the catch plate.

7. The organizing system according to claim 4, wherein an access area is defined by an approximately semicircular recess in an edge of the top portion of one packing box that is adjacent to an approximately semicircular recess in an edge of the top portion of an adjacent packing box at times when the packing boxes are engaged with the catch plate.

8. The organizing system according to claim 1, wherein the at least one packing box further includes at least one side wall, said organizing system further comprising a hanging bracket that is located on one of the side walls, said hanging bracket being moveable on bearings in a film hinge that can pivot to a position that is parallel to said side wall.

9. The organizing system according to claim 1, wherein the at least one packing box further includes at least one side wall, said organizing system further comprising comprises a hanging bracket that is disposed on an exterior surface of one of the side walls, said hanging bracket being capable of pivoting and engaging a catch stud on said side wall.

10. The organizing system according to claim 1, wherein the at least one leg on the at least one packing box is engageable with an opening of another packing box, wherein the opening is at the top of the containment area opposite the floor wall of the packing box, so that the packing boxes may be stacked one upon another.

11. The organizing system of claim 1 wherein said at least one leg comprises at least one pair of legs that are oriented obliquely away from each other.
